(19) United States
(12) Patent Application Publication
(10) Pub. No.: US 2012/0176354 A1
(43) Pub. Date: Jul. 12, 2012

(54) SUBSTRATE FOR LIQUID CRYSTAL DISPLAY DEVICE, LIQUID CRYSTAL DISPLAY DEVICE, AND METHOD FOR DRIVING LIQUID CRYSTAL DISPLAY DEVICE

(76) Inventors: Shohei Katsuta, Osaka-shi (JP); Tetsuya Ide, Osaka-shi (JP); Seiji Ohhashi, Osaka-shi (JP); Tsuyoshi Kamada, Osaka-shi (JP)

(21) Appl. No.: 13/497,111

(22) PCT Filed: Jul. 16, 2010
(86) PCT No.: PCT/JP2010/062096

§ 371 Date: Mar. 20, 2012

(30) Foreign Application Priority Data
Nov. 18, 2009 (JP) 2009-263021

(51) Int. Cl. G09G 3/36; G06F 3/038

(52) U.S. Cl. 345/204; 345/87

(57) ABSTRACT

In order to provide a liquid crystal display device substrate realizing high-speed driving and wide viewing angle characteristics, a liquid crystal display device substrate (1) includes: gate lines (12); source lines (14) crossing the gate lines (12); Cs lines (16) corresponding to the gate lines (12); TFTs (21) and (22), which are electrically connected with the gate lines (12) and the source lines (14); first and second pixel electrodes electrically connected with the TFTs (21) and (22); TFTs (23) electrically connected with the second pixel electrodes; control signal lines (18) corresponding to the gate lines (12) and electrically connected with gate electrodes of the TFTs (23), via which control signal lines (23) a control signal for controlling switching of the TFTs (23) between on/off conditions is supplied; and buffer capacitors Cs having first electrodes electrically connected with the TFTs (23) and second electrodes electrically connected with the Cs lines (16).

### TECHNICAL FIELD

The present invention relates to (i) a liquid crystal display device substrate for use in a display section of an electronic device, etc., (ii) a liquid crystal display device including the liquid crystal display device substrate, and (iii) a method for driving the liquid crystal display device.

### BACKGROUND ART

A liquid crystal display device has been widely used in a monitor device of a television receiver device or a personal computer, etc. in recent years. It is demanded that the liquid crystal display device in such use has an improved viewing angle characteristic so that a display screen can be viewed from any directions. A display screen with a decreased viewing angle characteristic has a drawback that, when it is viewed from an oblique direction, a difference between brightnesses in an actual driving voltage range is small. This phenomenon most significantly appears as a color change. For example, in a case where the display screen is viewed from the oblique direction, a color of an image appears whiter than in a case where the display screen is viewed from a front direction. As techniques for preventing the phenomenon, there are the following techniques each capable of obtaining a wide viewing angle characteristic.

Patent Literature 1 discloses a liquid crystal display device substrate having a pixel region having first and second sub pixels, the first sub pixel including a first pixel electrode connected with a first transistor and the second sub pixel including a second pixel electrode connected with a second transistor, the second pixel electrode being further connected with a third transistor. The third transistor is electrically connected with a gate bus line in a horizontal line immediately downstream of a gate bus line with which a gate electrode of the second transistor is connected. In the liquid crystal display device substrate, it is possible to cause a difference between voltages applied in the respective first and second sub pixels. As such, it is possible to realize a liquid crystal display device capable of obtaining a good display characteristic, particularly a wide viewing angle characteristic.

### CITATION LIST

### Patent Literature

Patent Literature 1
Japanese Patent Application Publication, Tokukai, No. 2006-133577 A (Publication Date: May 25, 2006)

### SUMMARY OF INVENTION

### Technical Problem

A display device capable of performing 3D display has been recently in widespread use. In a time-sharing manner, the 3D display is performed by displaying a right-eye image in a frame and a left-eye frame in a frame adjacent to the frame alternately. This requires doubling a normal driving speed to realize a driving speed of 120 Hz. However, even the driving speed of 120 Hz is not fast enough to secure a required display quality. In consideration, the time-sharing manner requires a driving speed of at least 240 Hz for high-speed driving.

A method that concurrently supplies scanning signals to respective two gate bus lines can be employed as a method for realizing the driving speed of 240 Hz by use of a liquid crystal display device substrate of a liquid crystal panel compatible with the driving speed of 120 Hz. With the method, in a case of driving a liquid crystal display panel having 1080 gate bus lines, for example, it is possible to supply scanning signals to the entire 1080 gate bus lines in a same time period as a time period conventionally required for supplying scanning signals to 540 gate bus lines. That is, it is possible to double the driving speed of 120 Hz so as to realize the driving speed of 240 Hz. Because the method does not require changing the liquid crystal panel depending on a driving method, it is possible to avoid an unnecessary cost increase.

However, in the technique of the patent literature 1, in a case of concurrently supplying scanning signals to respective two gate bus lines, it is inevitable to face the following problem.

In the liquid crystal display device substrate of the patent literature 1, charging with electricity is caused when a gate bus line is selected. Then, the charged electricity is redistributed when the third transistor is switched to the on condition in response to selection of a next gate bus line after a time period from the selection of the gate bus line.

This causes a voltage difference between the two sub pixels. In a case where two or more gate bus lines, e.g., n^{th} and (n+1)^{th} gate bus lines, are concurrent selected, the n^{th} gate line and the (n+1)^{th} gate bus line, which is in a horizontal line following the n^{th} gate bus line, are concurrently selected without a time lag between selection of them. On this account, the charged electricity redistributing capacitor is charged with the electricity at a same time as the pixel. This prevents the redistribution of the charged electricity and thereby causes no voltage difference between the two sub pixels. As such, it is impossible to improve the display quality such as the viewing angle characteristic, etc.

The present invention is made in view of the problem, and an object of the present invention is to provide (i) a liquid crystal display device substrate capable of realizing both high-speed driving and a wide viewing angle characteristic, (ii) a liquid crystal display device including the liquid crystal display device substrate, and (iii) a method for driving the liquid crystal display device.

### Solution to Problem

In order to attain the object, a liquid crystal display device substrate of the present invention includes: a plurality of scanning signal lines provided on a substrate so as to be juxtaposed to each other; a plurality of data signal lines provided so as to cross the plurality of scanning signal lines with an insulating film being disposed between the plurality of data signal lines and the plurality of scanning signal lines; a plurality of storage capacitor lines provided correspondingly to the respective plurality of scanning signal lines; first transistors and second transistors, wherein each of the first transistors and each of the second transistors are electrically connected with a predetermined one of the plurality of scanning signal lines and a predetermined one of the plurality of data signal lines; first pixel electrodes electrically connected with the respective first transistors; second pixel electrodes electrically connected with the respective second transistors and electrically disconnected from the respective first pixel electrodes; and pixel regions each having a first sub pixel in which a corresponding one of the first pixel electrodes is provided and a second sub pixel in which a corresponding one of the second pixel electrodes is provided, the liquid crystal display device substrate further including: a plurality of control signal lines provided additionally and correspondingly to the respective plurality of scanning signal lines; third transistors each being electrically connected with a corresponding one of the second pixel electrodes, and having a gate electrode being connected with that of the plurality of control signal lines which corresponds to one of the plurality of scanning signal lines which is connected with the corresponding one of the second pixel electrodes; and buffer capacitor sections each including a first buffer capacitor electrode electrically connected with a corresponding one of the third transistors and a second buffer capacitor electrode electrically connected with a corresponding one of the plurality of storage capacitor lines, the first buffer capacitor electrode and the second buffer capacitor electrode facing each other via an insulating film.

With the arrangement, the liquid crystal display device substrate includes the plurality of scanning signal lines and the plurality of data signal lines crossing the plurality of scanning signal line with the insulating film being disposed between them. The first transistors and the second transistors are provided for respective intersections of the plurality of scanning signal lines and the plurality of data signal lines, wherein each of the first transistors and each of the second transistors are electrically connected with the predetermined one of the plurality of scanning signal lines and the predetermined one of the plurality of data signal lines. The first transistors are electrically connected with the respective first pixel electrodes, and the second transistors are connected with the respective second pixel electrodes disconnected from the respective first pixel electrode. The liquid crystal display device substrate has the pixel regions each including the first sub pixel in which the corresponding one of the first pixel electrodes is provided and the second sub pixel in which the corresponding one of the second pixel electrodes is provided. The second pixel electrodes are further electrically connected with the respective third transistors. The liquid crystal display device substrate includes the control signal lines provided additionally and correspondingly to the respective plurality of scanning signal lines. The gate electrodes of the third transistors are connected with the respective plurality of control signal lines. The liquid crystal display device substrate further includes the plurality of storage capacitor lines provided correspondingly to the respective plurality of scanning signal lines. The liquid crystal display device substrate further includes the buffer capacitor sections.

Each buffer capacitor section includes the first buffer capacitor electrode and the second buffer capacitor electrode facing the first buffer capacitor electrode with the insulating film being disposed between them. Each first buffer capacitor electrode is electrically connected with a corresponding one of the third transistors, and each second buffer capacitor electrode is electrically connected with a corresponding one of the plurality of storage capacitor lines. Because the gate electrodes of the third transistors are electrically connected with the respective plurality of control signal lines, it is possible to control the on and off conditions of the third transistors by use of a voltage applied onto the control signal lines. Thus, the third transistors serve as respective switching devices for switching the second pixel electrodes and the first buffer capacitor electrodes between an electrically connected condition and an electrically disconnected condition, based on a signal supplied via the control signal lines.

The control signal lines, via each of which the signal for switching the second pixel electrodes and the first buffer capacitor electrodes between the electrically connected condition and the electrically disconnected condition is supplied, are provided additionally to the entire scanning signal lines. For this reasons, even in a case where two or more scanning signal lines are selected at a time, it is still possible to keep the second pixel electrodes and the first buffer capacitor electrodes, which are associated with the selected two or more scanning signal lines, to the electrically disconnected condition. Then, when the first and second transistors which are associated with the selected two or more scanning signal lines are turned off, the signals for switching the third transistors between the on and off conditions can be supplied to the respective plurality of control signal lines associated with the plurality of scanning signal lines. This can electrically connect the second pixel electrodes with the respective first buffer capacitor electrodes, thereby allowing transfer of charged electricity between each second pixel electrode and corresponding each of the first buffer capacitor electrodes. It is therefore possible to cause redistribution of the charged electricity in the sub pixels including the second pixel electrodes. Thus, even in a case where the signals for causing concurrent selection of the two or more scanning signal lines are supplied to the respective scanning signal lines, it is still possible to decrease voltages across the liquid crystal capacitances in the sub pixels including the second pixel electrodes. Therefore, with the liquid crystal display device substrate of the present invention, it is possible to realize high-speed driving by concurrently selecting two or more scanning signal lines, while maintaining a good display characteristic, particularly a wide viewing angle characteristic.

In order to obtain the object, a liquid crystal display device of the present invention includes: a liquid crystal display panel including a liquid crystal display device substrate described above, a counter substrate having common electrode provided therein, and a liquid crystal layer provided between the liquid crystal display device substrate and the common substrate; and control signal supply means for supplying, to the control signal lines respectively connected with the third transistors, a control signal for turning on the third transistors, wherein, when n^{th} one of the plurality of scanning signal lines is switched to a non-selection condition after a selection condition in which the n^{th} one of the plurality of scanning signal lines receives a scanning signal, the control signal supply means supplies the control signal to one control signal line connected with one third transistor associated with the n^{th} one of the plurality of scanning signal lines.

With the arrangement, it is possible to (i) keep the third transistor to the off condition during a time when the scanning signal line, with which the third transistor is associated with, is being selected, and (ii) switch the third transistor to the on condition when the scanning signal line, which has been selected by supplying thereto the scanning signal, is switched to the non-selection condition. As such, it is possible to cause the redistribution of charged electricity by (i) keeping the second pixel electrode and the first buffer capacitor electrode to the electrically disconnected condition while the scanning signal line, with which the second pixel electrode and the first buffer capacitor electrode are associated, is being selected and (ii) switching the second pixel electrode and the first buffer capacitor electrode to the electrically connected condition when the scanning signal line, which has been selected by supplying thereto the scanning signal, is switched to the non-selection condition. Thus, it is possible to provide a liquid crystal display device having a good display characteristic, particularly a wide viewing angle characteristic.

Further, even in a case where two or more scanning signal lines are concurrently selected, it is still possible to cause redistribution of charged electricity as follows: (i) keeping the second pixel electrode and the first buffer capacitor electrode to the electrically disconnected condition while the two or more scanning signal lines, with which the second pixel electrode and the first buffer capacitor electrode are associated, are being selected, and (ii) switching the second pixel electrode and the first buffer capacitor electrode to the electrically connected condition when the two or more scanning signal lines, which have been selected by supplying thereto the scanning signals, are switched to the non-selection condition. As such, even in a case of concurrently selecting the two or more scanning signal lines to drive the liquid crystal display device at a high driving speed, it is still possible to maintain the good display characteristic, particularly the wide viewing angle characteristic.

In order to attain the object, a method of the present invention for driving a liquid crystal display device is a method for driving a liquid crystal display device including a liquid crystal display device substrate, the liquid crystal display device substrate including (i) a plurality of scanning signal lines provided on a substrate so as to be juxtaposed to each other, (ii) a plurality of data signal lines provided so as to cross the plurality of scanning signal lines with an insulating film being disposed between the plurality of scanning signal lines and the plurality of data signal lines, (iii) a plurality of storage capacitor lines provided correspondingly to the respective plurality of scanning signal lines, (iv) first transistors and second transistors, wherein each of the first transistors and each of the second transistors are electrically connected with a predetermined one of the plurality of scanning signal lines and a predetermined one of the plurality of data signal lines, (v) first pixel electrodes electrically connected with the respective first transistors, and second pixel electrodes electrically connected with the respective second transistors and electrically disconnected from the respective first pixel electrodes, and (vi) pixel regions each having a first sub pixel in which a corresponding one of the first pixel electrodes is provided and a second sub pixel in which a corresponding one of the second pixel electrodes is provided, the liquid crystal display device substrate further including (vii) a plurality of control signal lines provided additionally and correspondingly to the respective plurality of scanning signal lines, (viii) third transistors each electrically connected with a corresponding one of the second pixel electrodes, and having a gate electrode being connected with that of the plurality of control signal lines which corresponds to one of the plurality of scanning signal lines which is connected with the corresponding one of the second pixel electrodes, and (ix) buffer capacitor sections each including a first buffer capacitor electrode electrically connected with a corresponding one of the third transistors and a second buffer capacitor electrode electrically connected with a corresponding one of the plurality of storage capacitor lines, the first and second buffer capacitor electrodes facing each other via an insulating film, the method including the steps of; concurrently supplying a scanning signal for turning on the first and the second transistors, to every group of m (where m is an integer of 2 or greater) of the plurality of scanning signal lines, which m of the plurality of scanning signal lines are adjacent to each other; and concurrently supplying, when r×m (where r is an integer of 1 or greater and m is an integer of 2 or greater) of the plurality of scanning signal lines, which r×m of the plurality of scanning signal lines are adjacent to each other, are switched to a non-selection condition after a selection condition in which the r×m of the plurality of scanning signal lines receive the scanning signal, a control signal for turning on the third transistors to r×m control signal lines associated with the respective r×m of the plurality of scanning signal lines

With the arrangement, the scanning signal for turning on the first and second transistors is supplied to the every group of m (where m is an integer of 2 or greater) scanning signal lines adjacent to each other. This makes it possible to realize high-speed driving. Further, it is also possible to keep electrically disconnecting the second pixel electrodes with the first buffer capacitor electrodes which are associated with the selected group of m scanning signal lines. When the first and second transistors associated with the selected scanning signal lines are switched to the off conditions, a signal for switching the third transistors between on and off conditions can be supplied to the two or more (r×m) control signal lines corresponding to the respective scanning signal lines. This electrically connects the second pixel electrode with the first buffer capacitor electrode, thereby allowing transfer of the charged electricity between each second pixel electrode and the corresponding buffer capacitor electrode and causing redistribution of the charged electricity in the sub pixel including the second pixel electrode. That is, with the driving method of the present invention for driving the liquid crystal display device, it is possible to realize high-speed driving by concurrently selecting two or more scanning signal lines, while maintaining a good display quality, particularly a wide viewing angle characteristic.

### Advantageous Effects of Invention

As described earlier, a liquid crystal display device substrate of the present invention includes (i) a plurality of scanning signal lines, (ii) a plurality of data signal lines, (iii) a plurality of capacitor lines, (iv) first transistors and second transistors, wherein each of the first transistors and each of the second transistors are electrically connected with a predetermined one of the plurality of scanning signal lines and a predetermined one of the plurality of data signal lines, and (v) first pixel electrodes and second pixel electrodes electrically disconnected from the respective first pixel electrodes, and further includes (vi) a plurality of control signal lines provided additionally and correspondingly to the respective plurality of scanning signal lines, (vii) third transistors each being electrically connected with a corresponding one of the second pixel electrodes, and having a gate electrode being connected with that of the control signal lines which corresponds to one of the plurality of scanning signal lines which is connected with the corresponding one of the second pixel electrodes, and (viii) buffer capacitor sections each including an electrode electrically connected with a corresponding one of the third transistors and an electrode electrically connected with a corresponding one of the plurality of storage capacitor lines. The use of the liquid crystal display device substrate allows even a driving method in which two or more scanning signal lines are concurrently selected to obtain an improved viewing angle characteristic of a liquid crystal display device. That is, it is possible to realize both high-speed driving and the wide viewing angle characteristic at a same time.

A method of the present invention for driving a liquid crystal display device is a method for driving a liquid crystal display device including a liquid crystal display device substrate including (i) a plurality of scanning signal lines, (ii) a plurality of data signal lines, (iii) a plurality of storage capacitor lines, (iv) first transistors and second transistors, wherein each of the first transistors and each of the second transistors are electrically connected with a predetermined one of the plurality of scanning signal lines and a predetermined one of the plurality of data signal lines, (v) first pixel electrodes and second pixel electrodes electrically disconnected from the respective first pixel electrodes, (vi) a plurality of control signal lines provided additionally and correspondingly to the respective plurality of scanning signal lines, (vii) third transistors each being electrically connected with a corresponding one of the second pixel electrodes, and having a gate electrode being connected with that of the plurality of control signal lines which corresponds to one of the plurality of scanning signal lines which is connected with the corresponding one of the second pixel electrodes, and (viii) buffer capacitor sections each including an electrode electrically connected with a corresponding one of the third transistors and an electrode electrically connected with a corresponding one of the plurality of the storage capacitor lines, the method including the steps of: concurrently supplying a scanning signal for turning on the first and the second transistors, to every group of m (where m is an integer of 2 or greater) of the plurality of scanning signal lines, which m of the plurality of scanning signal lines are adjacent to each other; and concurrently supplying, when r×m (where r is an integer of 1 or greater and m is an integer of 2 or greater) of the plurality of scanning signal lines, which r×m of the plurality of scanning signal lines are adjacent to each other, are switched to a non-selection condition after a selection condition in which the r×m of the plurality of scanning signal lines receive the scanning signal, a control signal for turning on the third transistors to r×m control signal lines associated with the respective r×m of the plurality of scanning signal lines. Thus, it is possible to improve a viewing angle characteristic of the liquid crystal display device, even in a case of concurrently selecting two or more scanning signal lines. That is, it is possible to realize both high-speed driving and a wide viewing angle characteristic at a same time.

### BRIEF DESCRIPTION OF DRAWINGS

FIG. 1 is an equivalent circuit view showing two adjacent pixels in a liquid crystal display device substrate in accordance with a present embodiment.

FIG. 2 is a view schematically describing a method for driving a liquid crystal display device, in accordance with the present embodiment.

FIG. 3 is a timing chart showing signals supplied to gate lines and control bus lines in the method, in accordance with the present embodiment.

FIG. 4 is another timing chart showing signals supplied to gate lines and control bus lines in the method, in accordance with the present embodiment.

FIG. 5 is a block view schematically showing an arrangement of the liquid crystal display device of the present invention.

### DESCRIPTION OF EMBODIMENTS

(Liquid Crystal Display Device)

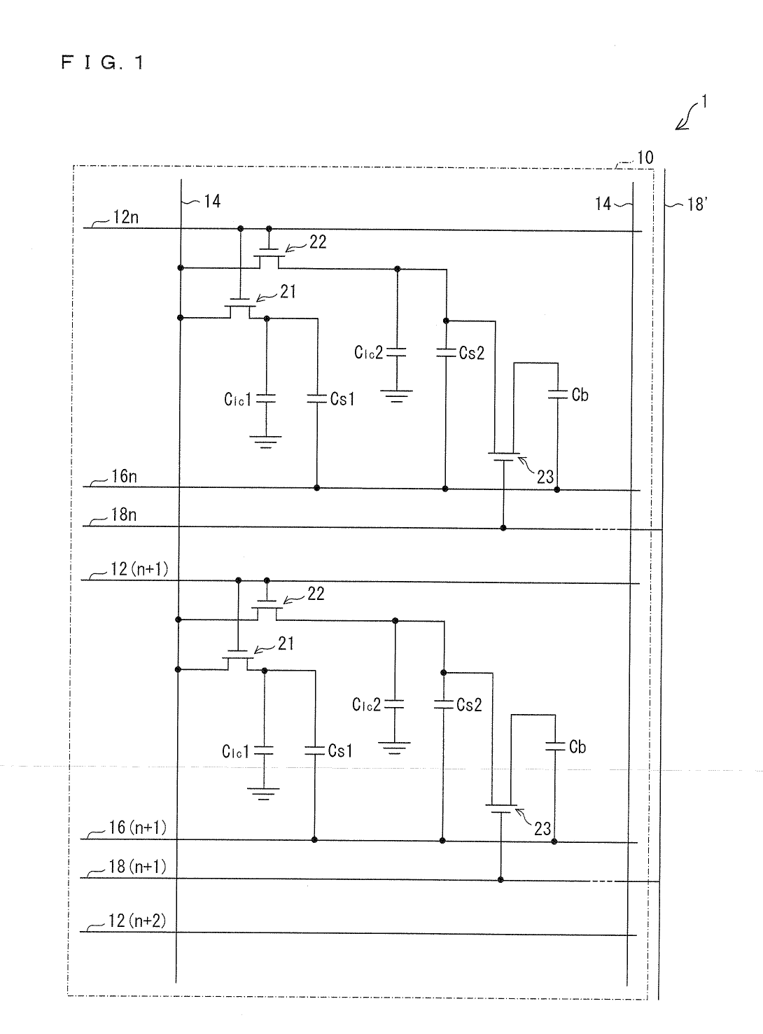

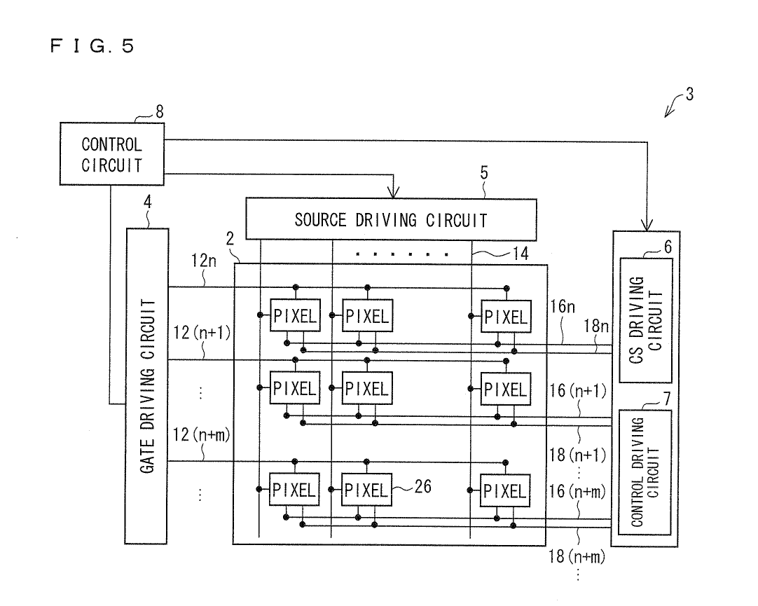

One embodiment of the present invention is described below with reference to FIGS. 1 through 5. First, a liquid crystal display device of the present embodiment is outlined. FIG. 5 is a block view schematically showing an arrangement of the liquid crystal display device in accordance with the present embodiment.

As shown in FIG. 5, a liquid crystal display device 3 of the present embodiment includes a liquid crystal display panel 2, a driving circuit for driving the liquid crystal panel 2, and a control circuit 8 for controlling driving of the driving circuit. The liquid crystal display device 3 may further include a backlight unit (which is not shown), etc. if necessary.

The driving circuit includes (i) a gate driving circuit (scanning signal supply means) 4 for supplying a scanning signal to a gate line (a scanning signal line) 12 in the liquid crystal display panel 2, (ii) a source driving circuit 5 for supplying a data signal to a source line (a data signal line) 14, (iii) a CS driving circuit 6 for supplying a signal to a Cs line (a storage capacitor line) 16, and (iv) a control driving circuit (control signal supply means) 7 for supplying a control signal to a control bus line (a control signal line) 18.

The gate driving circuit 4, the source driving circuit 5, the CS driving circuit 6, and the control driving circuit 7 are electrically connected with the gate line 12, the source line 14, the Cs line 16, and the control bus line 18, respectively, so as to be able to individually supply electric potentials to them from an outside. Each of the driving circuits is electrically connected with the control circuit 8 so as to be controlled by a control signal or an image signal supplied from the control circuit 8.

The gate driving circuit 4 is not limited to an arrangement that it supplies a scanning signal to one gate line 12 at a time. The gate driving circuit 4 may concurrently supply a scanning signal to two or more gate lines 12 by concurrently selecting the two or more gate lines 12.

Similarly, the control driving circuit 7 is not limited to an arrangement that it supplies a control signal to one control bus line 18 at a time. The control driving circuit 7 may concurrently supply a control signal to two or more control bus lines 18 by concurrently selecting the two or more control bus lines 18.

The gate line 12 and the source line 14 are provided so as to cross each other. A region surrounded by the gate lines 12 and the source lines 14 corresponds to one pixel. As later described, the one pixel is made up of sub pixels A and B.

The liquid crystal display panel 2 includes (i) a liquid crystal display device substrate 1 (which is later described), (ii) a counter substrate having a common electrode, color filters (CF), etc. provided therein, and (iii) a liquid crystal layer provided between the liquid crystal display substrate 1 and the counter substrate. Liquid crystals of the liquid crystal layer have a negative dielectric anisotropy, for example. A wave plate, a polarization plate, etc. (none of which is shown) may be provided outside the liquid crystal display device substrate 1 and the counter substrate, if necessary.

(Liquid Crystal Display Device Substrate)

The following describes a circuit arrangement of the liquid crystal display device substrate 1 with reference to FIG. 1. FIG. 1 is an equivalent circuit view showing adjacent two pixels in the liquid crystal display device substrate in accordance with the present embodiment. As shown in FIG. 1, the liquid crystal display device substrate 1 includes (i) a plurality of gate lines 12 provided so as to be juxtaposed to each other, (ii) a plurality of source lines 14 provided so as to cross the respective plurality of gate lines 12 with an insulating film (which is not shown) being disposed therebetween, (iii) a plurality of Cs lines provided correspondingly to the respective plurality of gate lines 12, (iv) a plurality of control bus lines 18 provided correspondingly to the respective plurality of gate lines 12, (v) TFTs (thin film transistors, first transistors) 21, (vi) TFTs (second transistors) 22, and (vii) TFTs (third transistors) 23. The liquid crystal display device substrate 1 serves as an active matrix substrate in the liquid crystal display panel 2. The constituents of the liquid crystal display device substrate 1 are provided on and above a transparent substrate such as a glass substrate, etc.

The plurality of gate lines 12 are sequentially scanned line by line, for example. FIG. 1 shows an n^{th} gate line 12n (i.e., a gate line 12 in an n^{th} horizontal line) which is scanned in an n^{th} order in a one frame, a (n+1)^{th} gate line 12(n+1) which is scanned in a (n+1)^{th} order in the one frame, and a (n+2)^{th} gate line 12(n+2) which is scanned in a (n+2)^{th} order in the one frame.

In each pixel, a TFT 21 and a TFT 22 are adjacently provided near an intersection of a gate line 12 and a corresponding source line 14. A part of the gate line 12 serves as gate electrodes of the TFTs 21 and 22. Operation semiconductor layers of the respective TFTs 21 and 22 are integrally provided on the gate line 12 with an insulating film (which is not shown) being disposed between the operation semiconductor layers of the respective TFTs 21 and 22 and the gate line 12, for example. Also, channel protection films of the TFTs 21 and 22 are integrally provided on the respective operation semiconductor layers, for example. The following (i) and (ii) are provided on the channel protection film of the TFT 21 so as to be spaced away from each other by a predetermined distance and face each other, (i) a drain electrode and an n-type impurity semiconductor layer provided below the drain electrode and (ii) a source electrode and an n-type impurity semiconductor layer provided below the source electrode. Similarly, the following (iii) and (iv) are provided on the channel protection film of the TFT 22 so as to be spaced away from each other by a predetermined distance and face each other, (iii) a drain electrode and an n-type impurity semiconductor layer provided below the drain electrode and (iv) a source electrode and an n-type impurity semiconductor layer provided below the source electrode. The source electrodes of the TFTs 21 and 22 are electrically connected with the source line 14. The TFTs 21 and 22 are juxtaposed to each other.

A Cs line 16 is provided so as to extend in a direction in which the gate line 12 extends, so as to cross a pixel region defined by the gate lines 12 and the sources line 14.

FIG. 1 shows a Cs line 16n provided between the gate lines 12n and 12(n+1) and a Cs line 16(n+1) provided between the gate lines 12(n+1) and 12(n+2). The Cs line 16n is associated with a pixel controlled via the gate line 12n. From this perspective, the present Specification describes that the Cs line 16n is associated with the gate line 12n.

In each pixel, a storage capacitor electrode is provided above the Cs line 16 with an insulating film being disposed between them. The storage capacitor electrode is electrically connected with a drain electrode of the TFT 21 via a connection electrode. A storage capacitance Cs1 is formed between the Cs line 16 and the storage capacitor electrode facing each other via the insulating film. It is shown that the Cs line 16n and the Cs line 16(n+1) are adjacent to each other, like the gate line 12n and the gate line 12(n+1) are adjacent to each other.

A control bus line 18 is a line via which a signal for switching a TFT 23 between on and off conditions is supplied to a TFT 23 connected with the control bus line 18. The control bus line 18 is provided so as to extend in a direction in which the plurality of gate lines 12 extend, so as to cross a pixel region defined by a gate line 12 and a corresponding source line 14. FIG. 1 shows a control bus line 18n provided between the gate line 12n and the gate line 12(n+1) and a control bus line 18(n+1) provided between the gate line 12(n+1) and the gate line 12(n+2). The control bus line 18n is associated with the pixel which is controlled via the gate line 12n. From such a perspective, the present Specification describes that the control bus line 18n is associated with the gate line 12n.

As later described, the control driving circuit 7 is not limited to an arrangement that it supplies a signal to one control bus line 18 at a time. The control driving circuit 7 may concurrently supply the signal to two or more control bus lines 18 which are adjacent to each other. From this perspective, the two or more control bus lines 18, to which the signal may be concurrently supplied, may be configured as control bus lines 18′ connected with each other in a frame region outside of the display region 10 including entire pixel regions.

In each pixel shown in FIG. 1, the TFT 23 is provided in that area of the pixel region which is close to a bottom of a sheet on which FIG. 1 is illustrated. A gate electrode of the TFT 23 is electrically connected with a control bus line 18 associated with the pixel. That is, the gate electrode of the TFT 23 in a pixel region to which the gate line 12n is associated is connected with the control bus line 18n. Though it is not shown, an operation semiconductor layer is provided above the gate electrode of the TFT 23 with an insulating film being disposed therebetween. A channel protection film is provided on the operation semiconductor layer. Further, the following (i) and (ii) are provided on the channel protection film so as to be spaced away from each other by a given distance and face each other, (i) a drain electrode and an n-type impurity semiconductor layer provided below the drain electrode and (ii) a source electrode and an n-type impurity semiconductor layer provided below the source electrode. The drain electrode of the TFT 23 is electrically connected with a pixel electrode of the sub pixel B (which is later described) via a contact hole.

Provided near the TFT 23 is a first buffer capacitor electrode electrically connected with the Cs line 16 via a connection electrode. A second buffer capacitor electrode is provided above the first buffer capacitor electrode with an insulating film disposed therebetween. The second buffer capacitor electrode is electrically connected with a source electrode of the TFT 23. A buffer capacitor (i.e., buffer capacitor section) Cb is formed between the first and second buffer capacitor electrodes that face each other via the insulating film.

The pixel region of one pixel, which is defined by the gate lines 12 and the source lines 14, is divided into sub pixels A and B. The sub pixel A has a trapezoid-like shape, for example, and is provided to the left in a central part of the pixel region. The sub pixel B is provided in the rest of the pixel region, i.e., provided to the right in the central part of the pixel region and in upper and lower areas of the pixel region. The sub pixels A and B in the pixel region are located substantially line-symmetrically with respect to a corresponding Cs line 16, for example.

The sub pixel A includes a first pixel electrode (first one of pixel electrodes) provided therein, and the sub pixel B includes a second pixel electrode (second one of the pixel electrodes) provided therein and electrically disconnected from the first electrode. Both of the first and second pixel electrodes are made from a transparent conductive film such as ITO, etc. In order for the liquid crystal display device substrate to have an improved viewing angle characteristic, it is preferable that an area ratio of the sub pixel B to the sub pixel A is ½ or greater but not greater than 4.

The first pixel electrode of the sub pixel A is electrically connected with the following (i) and (ii) via a contact hole opened in the protection layer, (i) the storage capacitor electrode forming the storage capacitance Cs1 and (ii) the drain electrode of the TFT 21. The second pixel electrode of the sub pixel B is electrically connected with the drain electrode of the TFT 22 via a contact hole opened in the protection film. Also, the second pixel electrode of the sub pixel B has a region overlapping with the Cs line 16 via the protection film and the insulating film. In the region, a storage capacitance Cs2 is formed between the second pixel electrode and the Cs line 16 that face each other via the protection layer and the insulating film.

(Counter Substrate)

The counter substrate includes a CF resin layer provided on a glass substrate and a common electrode provided on the CF resign layer. A liquid crystal capacitor Clc1 is formed between the first pixel electrode of the sub pixel A and the common electrode that face each other via the liquid crystal layer. A liquid crystal capacitor Clc2 is formed between the second pixel electrode of the sub pixel B and the common electrode that face each other via the liquid crystal layer. An alignment film is provided in each of an interface with the liquid crystal layer of the liquid crystal display device substrate 1 and an interface between the liquid crystal layer and the counter substrate.

(Method for Driving Liquid Crystal Display Device)

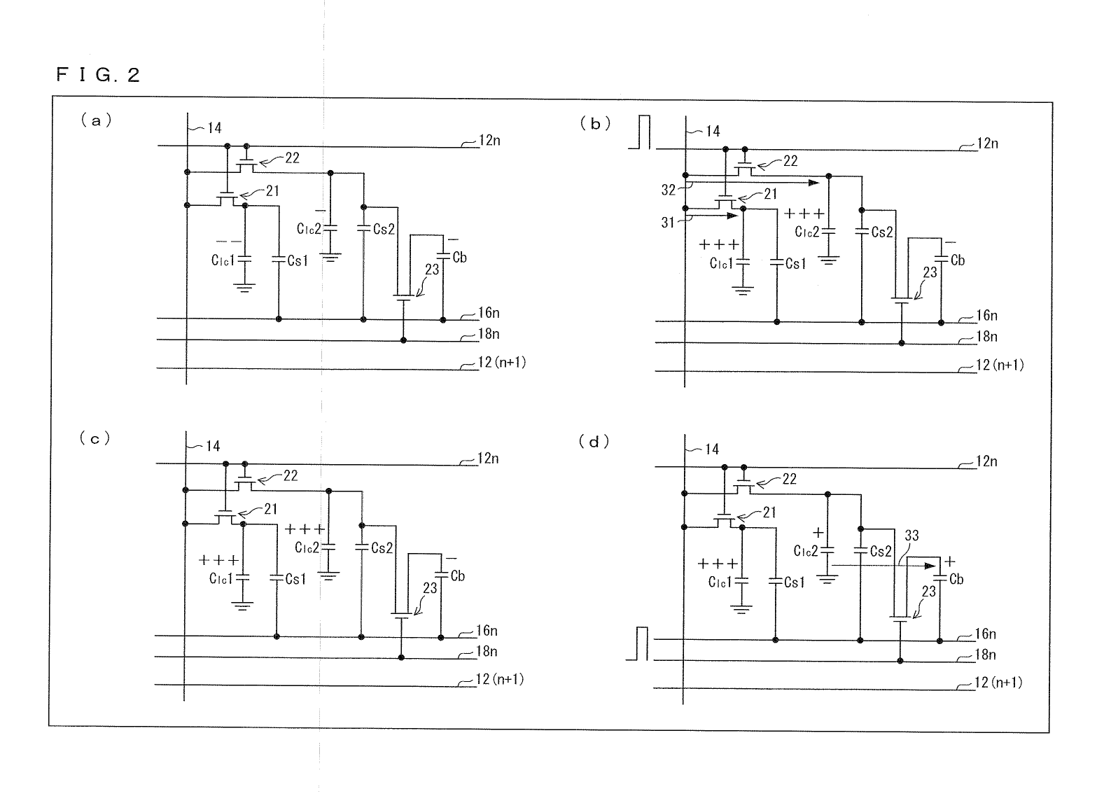

The method for driving the liquid crystal display device 3 is described below with reference to FIGS. 2 through 4.

In the method of the present embodiment, the following (i) and (ii) are electrically charged by turning on the TFTs 21 and 22, (i) the liquid crystal capacitor Clc1 and the storage capacitor Cs1 of the sub pixel A and (ii) the liquid crystal capacitor Clc2 and the storage capacitor Cs2. Thereafter, the TFT 23 is turned on while the TFTs 21 and 22 are being turned off, so as to cause redistribution of an electrical charge between (a) the liquid crystal capacitor Clc2 and the storage capacitor Cs2 of the sub pixel B and (b) a buffer capacitor Cb. This causes a voltage difference between the sub pixels A and B. Therefore, it is possible to improve the viewing angle characteristic.

(a) through (d) of FIG. 2 are views schematically showing, in a time sequential order, how the charged electricity is stored and transferred in a circuit on the liquid crystal display device substrate 1.

(a) of FIG. 2 is a view showing a condition (initial condition) obtained immediately before the selection of the gate line 12n. Assume that a negative data signal was written in a previous frame. In this case, the negative data signal has been written into the liquid crystal capacitors Clc1 and Clc2 and the buffer capacitor Cb in the initial condition.

(b) of FIG. 2 is a view showing a condition that the charged electricity is transferred and stored in response to the selection of the n^{th} gate line 12n (which is in the n^{th} horizontal line) after the condition shown in (a) of FIG. 2. The TFTs 21 and 22 are turned on in response to a voltage applied thereto during a time when the gate line 12n is being selected. This causes a positive data signal to be written into the storage capacitors Clc1 and Clc2 from the source line 14, as shown in the arrows 31 and 32. Meanwhile, no voltage is applied to the control bus line 18n. In this case, the TFT 23 is kept to be turned off. This keeps the buffer capacitor Cb in the initial condition.

(c) of FIG. 2 is a view showing a condition following the condition shown in (b) of FIG. 2, that the selection of the gate line 12n is ended before the control bus line 18n is selected. In this condition, voltages applied across the respective liquid crystal capacitors Clc1 and Clc2 are same with each other in terms of an electric potential. Further, the buffer capacitor Cb is kept to a same condition as the initial condition.

(d) of FIG. 2 shows a condition following the condition shown in (c) of FIG. 2, that the charged electricity is transferred and stored in response to the selection of the control bus line 18n corresponding to the gate line 12n. In this condition, the TFTs 21 and 22 are turned off, whereas the TFT 23 is turned on. When the TFT 23 is turned on, redistribution of the charged electricity is caused in which the charged electricity is transferred from the liquid crystal capacitor Clc2 and the storage capacitor Cs2 to the buffer capacitor Cs2 (see the arrow 33 in (d) of FIG. 2) so that voltages applied across respective of the liquid crystal capacitors Clc2, the storage capacitors Cs2, and the buffer capacitors Cb have equilibrium. In normal driving in which a polarity of an application voltage (i.e., the polarity of the data signal) is reversed every frame, a polarity of the charged electricity which has been stored in the buffer capacitance Cb is opposite to a polarity of the charged electricity which is newly supplied to the buffer capacitor Cb. On this account, an amount of the entire charged electricity in the liquid crystal capacitor Clc2, the storage capacitor Cs2, and the buffer capacitor Cb is decreased, thereby causing decreases in voltages applied across the respective of the liquid crystal capacitors Clc2, the storage capacitor Cs2, and the buffer capacitor Cb. That is, with the method of the present embodiment for driving the liquid crystal display device, it is possible to realize high-speed driving by concurrently selecting two or more scanning signal lines, while maintaining the wide viewing angle characteristic.

In the sub pixel A, in contrast to the sub pixel B, no phenomenon like the redistribution of the charged electricity is caused even when the TFT 23 is turned on. Therefore, the voltage applied across the liquid crystal capacitor Clc1 in the sub pixel A remains unchanged irrespectively of the selection of the control bus line 18n.

This causes a difference between the voltage applied across liquid crystal capacitor Clc1 in the sub pixel A and the voltage applied across the liquid crystal capacitor Clc2 in the sub pixel B. Therefore, it is possible to improve the viewing angle characteristic.

In the method of the present embodiment, the following signal (i) instead of the following signal (ii) is used for switching the TFT 23 between on/off conditions so as to cause the redistribution of the charged electricity; (i) the signal supplied via the control bus line 18n provided independently of the gate line, and (ii) the signal supplied via the gate line 12(n+1) following the gate line 12n. In this case, it is possible to cause the redistribution of the charged electricity in each pixel region corresponding to a selected gate line(s) 12, irrespectively of how many gate lines 12 (either one gate line 12 or two or more gate lines 12) are selected.

In a case where the gate lines 12n and 12(n+1) are concurrently selected, for example, each of TFTs 21 and 22 connected with them are turned on so that voltages are applied onto liquid crystal capacitors Clc1 and Clc2. The control bus lines 18n and 18(n+1), which correspond to the gate lines 12n and 12(n+1), are not selected during a time when the gate lines 12n and 12(n+1) are being selected. Thus, each TFT 23 is turned off, and each buffer capacitor Cb is kept to the initial condition. After the TFTs 21 and 22 are turned off, the control bus lines 18n and 18(n+1) are concurrently selected so that the TFT 23 is turned on. This can cause redistribution of the charged electricity between (i) the liquid crystal capacitor Clc2 and the storage capacitor C2 and (ii) the buffer capacitor Cb. This can cause a voltage difference between the liquid crystal capacitor Clc1 of the sub pixel A and the liquid crystal capacitor Clc2 of the sub pixel B in each of pixel regions associated with the gate lines 12n and 12(n+1). As such, it is possible to improve the viewing angle characteristic, even in a case of concurrently selecting the two or more gate lines 12.

In contrast to this, in a case of using a liquid crystal display device substrate having a conventional arrangement that (i) no control bus line 18 is provided and (ii) a gate electrode of a TFT 23 is connected with a next gate line 12, it is impossible to cause redistribution of charged electricity as appropriate when concurrently selecting two or more gate lines 12. A reason for this is described below in detail. For easy explanation, members having like functions as the constituents of the liquid crystal display device substrate 1 of the present invention are given like reference signs and described.

In the liquid crystal display device substrate having the conventional arrangement, a gate electrode of a TFT 23 provided in a pixel defined by a gate line 12n and source lines 14 (for easy description, the pixel is hereinafter referred to as a pixel associated with the gate line 12n) is connected with a next gate line 12(n+1). Similarly, a gate electrode of a TFT 23 provided in a pixel defined by a gate line 12(n+1) and the source lines 14 (for easy description, the pixel is hereinafter referred to as a pixel associated with the gate line 12(n+1)) is connected with a next gate line 12(n+2).

In a liquid crystal display device substrate including the liquid crystal display device substrate thus having the conventional arrangement, (i) TFTs 21 and 22 connected with the gate line 12n and (ii) TFTs 21 and 22 connected with the gate line 12(n+1) are turned on when the gate lines 12n and 12(n+1) are concurrently selected. This causes application of voltages onto liquid crystal capacitors Clc1 and Clc2.

At this time, because the gate line 12(n+2) is not selected, the TFT 23 connected with it is turned off. This causes the buffer capacitor Cb in the pixel associated with the gate line 12(n+1) to be kept to the initial condition. Thereafter, the TFT 23 is turned on when the gate line 12(n+2) and a gate line 12(n+3) are selected. This causes a redistribution of charged electricity in one sub pixel of a pixel region associated with the gate line 12(n+1).

On the other hand, in a case where the gate lines 12n and 12(n+1) are concurrently selected, a TFT 23 connected with the gate line 12(n+1) is turned on because the gate line 12(n+1) is selected. Thus, in a pixel associated with the gate line 12n, a buffer capacitor Cb is electrically charged during a time when the gate line 12n is selected, so as to have an electrical potential same as electric potentials at liquid crystal capacitors Clc1 and Clc2. Thereafter, the gate line 12(n+1) is switched to a non-selection condition when the gate line 12 is switched to a non-selection condition. This turns off the TFT 23 provided in the pixel region associated with the gate line 12n. As a result, no redistribution of charged electricity is caused in the pixel associated with the gate line 12n. As such, it is impossible to cause a difference in electric potential between the sub pixels A and B. That is, in a case of using the liquid crystal display device substrate having the conventional arrangement, it is difficult to realize high-speed driving by concurrently selecting two or more scanning signal lines, while maintaining the wide viewing angle characteristic.

The embodiment deals with a case that two gate lines 12 are concurrently selected. Alternatively, even in a case of concurrently selecting three or more gate lines 12, it is still possible to maintain the wide viewing angle. That is, in a case of concurrently selecting a group of m gate lines 12n to 12(n+m−1) (i.e., n^{th} gate line 12 to (n+m−1)^{th} gate line 12), it is possible to keep, to original conditions, the buffer capacitors Cb associated with them. Thereafter, by selecting control bus lines 18n to 18(n+m−1) (i.e., n^{th} control bus line to (n+m−1)^{th} control bus line) while these gate lines 12 are being selected, it is possible to cause redistribution of charged electricity in each sub pixel B. Thus, even in a case where the group of m gate lines 12 are concurrently selected, it is still possible to cause a voltage difference between the respective liquid crystal capacitors Clc1 and Clc2 in sub pixels A and B of each pixel.

A timing of supply of the signal to the control bus line 18 is not particularly limited, as long as the signal is supplied to the control bus line 18 after the selection of a corresponding gate line 12.

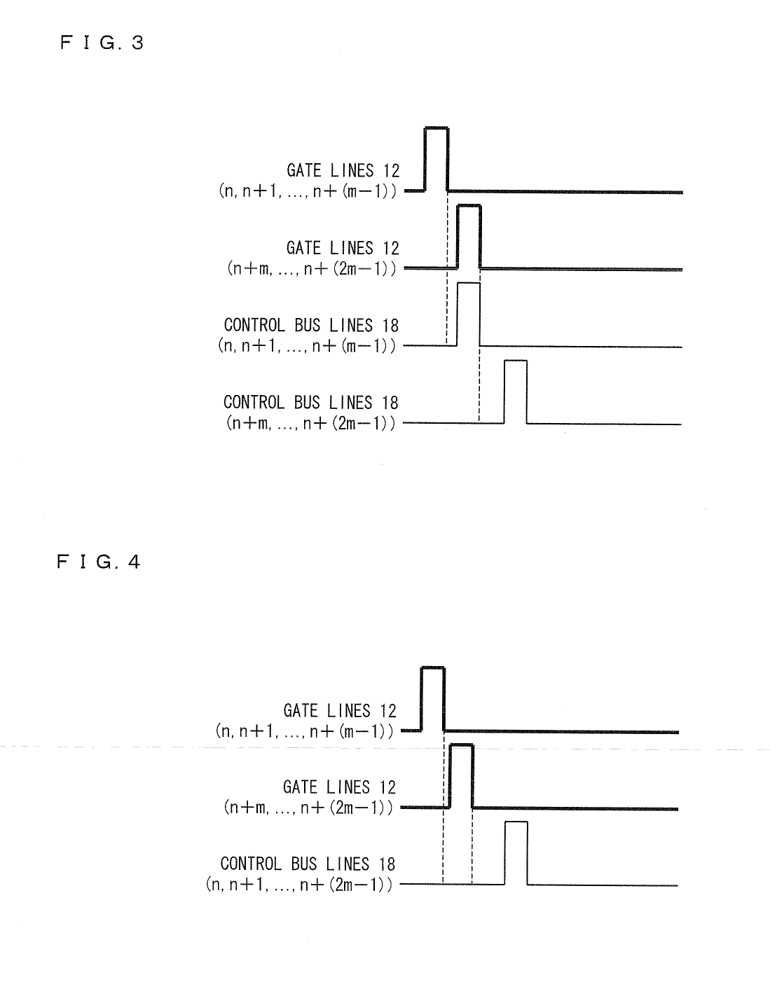

FIG. 3 is a chart view showing timings of a scanning signal supplied to gate lines 12 and timings of a control signal supplied to control bus lines 18. In FIG. 3, the horizontal axis indicates a time and the vertical axis indicates a voltage. In the method for driving shown in FIG. 3, every group of m gate lines 12 are concurrently selected each time. While a voltage of a scanning signal is being applied to the gate lines 12n, 12(n+1), . . . , and 12(n+m−1), corresponding control bus lines 18n, 18(n+1), . . . , and 18(n+m−1) are being kept to non-selection conditions. Thereafter, the control bus lines 18n, 18(n+1), . . . , and 18(n+m−1) are switched to selection conditions when a next group of m gate lines 12(n+m), 12(n+m+1), . . . and 12(n+2m−1) are selected. Meanwhile, control bus lines 18(n+m), 18(n+m+1), . . . , and 18(n+2m−1) are kept to non-selection conditions. Thereafter, the control bus lines 18(n+m), 18(n+m+1), . . . , and 18(n+2m−1) are switched to selection conditions when the group of m gate lines 12(n+m), 12(n+m+1), . . . , and 12(n+2m−1) are switched to non-selection conditions. Thus, even in a case of concurrently selecting the group of m gate lines, it is still possible to cause redistribution of charged electricity in the sub pixel B of each pixel region.

The use of the following arrangement enables making it easy to concurrently select the group of m control bus lines 18, the arrangement that the group of m control bus lines to be concurrently selected are connected with each other in a frame region outside of the display region 10 including the entire pixel regions. Alternatively to the arrangement, it may be arranged so that each pair of s (where s is an aliquot of m, excluding 1) control bus lines, out of the m control bus lines which are concurrently selected, are connected with each other.

The number of gate lines 12 which are selected at a time may be different from the number of control bus lines 18 which are selected at a time. FIG. 4 is a chart view showing timings of a scanning signal and a control signal in a case where the number of concurrently selected control bus lines 18 is different from the number of concurrently selected gate lines 12. In the method in which a group of m gate lines 12 are concurrently selected, a group of 2m control bus lines 18 (i.e., control bus lines 18n to 18(n+2m−1)) may be concurrently selected after the following events (i) through (iii); (i) gate lines 12n, 12(n+1), . . . , and 12(n+m−1) are selected, (ii) the gate lines 12(n+m), 12(n+m+1), . . . , and 12(n+2m−1) are selected, and (iii) the gate lines 12n, 12(n+1), . . . , 12(n+m−1) and the gate lines 12(n+m), 12(n+m+1), . . . , and 12(n+2m−1) are switched to the non-selection conditions (see FIG. 4). That is, it may be possible that, after the gate driving circuit 4 concurrently supplies a scanning signal to a group of r×m (where r is an integer of 1 or more) gate lines 12 (i.e., n^{th} gate line 12n to (n+rm−1)^{th} gate line 12), a control signal is supplied concurrently to a group of r×m control bus lines 18 corresponding to the group of r×m gate lines 12. In this case, the number of drivers for the control bus lines 18 can be decreased to be smaller than the number of drivers for the gate lines 12. As such, it is possible to improve a yield ratio and thereby reduce a cost.

Each gate line 12 is periodically switched to the selection condition. It is preferable that each control bus line is periodically switched to the selection condition at same cycle as the gate line 12. In a case where the control signal is periodically supplied to the gate bus line 18 at the same cycle as supply of the scanning signal to the gate bus line 12, a time lag between voltage application to liquid crystal capacitor and occurrence of redistribution of charged electricity is uniform for each pixel. It is therefore possible to prevent a decrease in a display quality of a liquid crystal display device.

The present invention is not limited to the embodiment, but may be altered by a skilled person within the scope of the claims. That is, an embodiment derived from a proper combination of technical means altered as appropriate within the scope of the claims is encompassed in the technical scope of the present invention.

It is preferable that the liquid crystal display device substrate of the present invention is arranged so that two or more of the plurality of control signal lines are connected with each other outside a display region formed by the entire pixel regions.

With the arrangement, it is possible to concurrently supply a same signal to two or more control signal lines connected with each other.

Further, it is preferable that the liquid crystal display device of the present invention is arranged so that cycles of supply of the scanning signal to the plurality of scanning signal lines are same as cycles of the supply of the control signal which is supplied to the plurality of control signal lines by the control signal supply means.

With the arrangement, a timing of redistribution of charged electricity is same for each pixel. This makes it possible to prevent a decrease in a display quality of a liquid crystal display device.

Further, it is preferable that the liquid crystal display device of the present invention further includes scanning signal supply means for supplying a scanning signal to the plurality of scanning signal lines in such a manner that the scanning signal supply means supplies the scanning signal to every group of m (where m is an integer of 2 or greater) of the plurality of scanning signal lines, which m of the plurality of scanning signal lines are adjacent to each other, the control signal supply means concurrently supplying, when m of the plurality of scanning signal lines are switched to the non-selection condition after the selection condition in which the m of the plurality of scanning signal lines receive the scanning signal supplied from the scanning signal supply means, the control signal to m (where m is an integer of 2 or greater) control signal lines associated with the respective m of the plurality of scanning signal lines.

With the arrangement, the scanning signal supply means can concurrently supply the scanning signal to the group of m scanning signal lines, and the control signal supply means can concurrently supply the control signal to the group of m numbers of control signal lines. Further, the liquid crystal display device includes the liquid crystal display device substrate early described. On this account, it is possible to (i) realize high-speed driving of the liquid crystal display device by concurrently selecting two or more scanning signal lines and (ii) maintaining a good display characteristic, particularly a wide viewing angle characteristic.

Further, it is preferable that the liquid crystal display device of the present invention further includes scanning signal supply means for supplying a scanning signal to the plurality of scanning signal lines in such a manner that the scanning signal supply means supplies the scanning signal to every group of m (where m is an integer of 2 or greater) of the plurality of scanning signal lines, which m of the plurality of scanning signal lines are adjacent to each other, the control signal supply means concurrently supplying, when r×m (where r is an integer of 2 or greater) of the plurality of scanning signal lines, which r×m of the plurality of scanning signal lines are adjacent to each other, are switched to the non-selection condition after the selection condition in which the r×m of the plurality of scanning signal lines receive the scanning signal supplied from the scanning signal supply means, the control signal to r×m (where r is an integer of 2 or greater and m is an integer of 2 or greater) control signal lines associated with the respective r×m of the plurality of scanning signal lines.

With the arrangement, the scanning signal supply means can concurrently supply the scanning signal to the m scanning signal lines, whereas the control signal supply means can concurrently supply the control signal to the r×m control signal lines. In this case, by concurrently selecting two or more scanning signal lines, it is possible to cause high-speed driving of the liquid crystal display device and maintain a good display characteristic, in particular, a good wide viewing angle characteristic. Further, it is possible to reduce the number of drivers for supplying control signals to control lines to 1/(r×m) of the number of drivers for supplying scanning signals to scanning signal lines. This makes it possible to improve a yield ratio and thereby reduce a cost.

(Supplementary Note)

The liquid crystal display device substrate of the present invention can be also described to have the following feature. That is, the liquid crystal display device substrate of the present invention has a pixel structure that a bus line periodically synchronized with a gate line is provided, a third TFT in a pixel is connected with the bus line, and a sub pixel and a charged electricity redistributing capacitor are connected with each other via the third TFT in the pixel.

### INDUSTRIAL APPLICABILITY

The present invention is widely applicable to display devices in general which include liquid crystal display devices employing liquid crystal display panels.

### REFERENCE SIGNS LIST

1: liquid crystal display device substrate
2: liquid crystal display panel
3: liquid crystal display device
4: gate driving circuit (scanning signal supply means)
5: source driving circuit
6: CS driving circuit
7: control driving circuit (control signal supply means)
8: control circuit
10: display region
12: gate line (scanning signal line)
14: source line
16: Cs line (storage capacitor line)
18, 18′: control bus line (control signal line)
21: TFT (first transistor)
22: TFT (second transistor)
23: TFT (third transistor)

1. A liquid crystal display device substrate, comprising:
a plurality of scanning signal lines provided on a substrate so as to be juxtaposed to each other;
a plurality of data signal lines provided so as to cross the plurality of scanning signal lines with an insulating film being disposed between the plurality of data signal lines and the plurality of scanning signal lines;
a plurality of storage capacitor lines provided correspondingly to the respective plurality of scanning signal lines;
first transistors and second transistors, wherein each of the first transistors and each of the second transistors are electrically connected with a predetermined one of the plurality of scanning signal lines and a predetermined one of the plurality of data signal lines;
first pixel electrodes electrically connected with the respective first transistors;
second pixel electrodes electrically connected with the respective second transistors and electrically disconnected from the respective first pixel electrodes; and pixel regions each having a first sub pixel in which a corresponding one of the first pixel electrodes is provided and a second sub pixel in which a corresponding one of the second pixel electrodes is provided,
the liquid crystal display device substrate further comprising:
a plurality of control signal lines provided additionally and correspondingly to the respective plurality of scanning signal lines;
third transistors each being electrically connected with a corresponding one of the second pixel electrodes, and having a gate electrode being connected with that of the plurality of control signal lines which corresponds to one of the plurality of scanning signal lines which is connected with the corresponding one of the second pixel electrodes; and
buffer capacitor sections each including a first buffer capacitor electrode electrically connected with a corresponding one of the third transistors and a second buffer capacitor electrode electrically connected with a corresponding one of the plurality of storage capacitor lines, the first buffer capacitor electrode and the second buffer capacitor electrode facing each other via an insulating film.

2. The liquid crystal display device as set forth in claim 1, wherein
two or more of the plurality of control signal lines are connected with each other outside a display region formed by the entire pixel regions.

3. A liquid crystal display device comprising:
a liquid crystal display panel including (i) a liquid crystal display device substrate as set forth in claim 1, (ii) a counter substrate having a common electrode provided therein, and (iii) a liquid crystal layer provided between the liquid crystal display device substrate and the common substrate; and
control signal supply means for supplying, to the control signal lines respectively connected with the third transistors, a control signal for turning on the third transistors, wherein, when n^{th} one of the plurality of scanning signal lines is switched to a non-selection condition after a selection condition in which the n^{th} one of the plurality of scanning signal lines receives a scanning signal, the control signal supply means supplies the control signal to one control signal line connected with one third transistor associated with the n^{th} one of the plurality of scanning signal lines.

4. The liquid crystal display device as set forth in claim 3, wherein
cycles of supply of the scanning signal to the plurality of scanning signal lines are same as cycles of the supply of the control signal which is supplied to the plurality of control signal lines by the control signal supply means.

5. The liquid crystal display device as set forth in claim 4, further comprising:
scanning signal supply means for supplying a scanning signal to the plurality of scanning signal lines in such a manner that the scanning signal supply means supplies the scanning signal to every group of m (where m is an integer of 2 or greater) of the plurality of scanning signal lines, which m of the plurality of scanning signal lines are adjacent to each other,
the control signal supply means concurrently supplying, when m of the plurality of scanning signal lines are switched to the non-selection condition after the selection condition in which the m of the plurality of scanning signal lines receive the scanning signal supplied from the scanning signal supply means, the control signal to m (where m is an integer of 2 or greater) control signal lines associated with the respective m of the plurality of scanning signal lines.

6. The liquid crystal display device as set forth in claim 4, further comprising:
scanning signal supply means for supplying a scanning signal to the plurality of scanning signal lines in such a manner that the scanning signal supply means supplies the scanning signal to every group of m (where m is an integer of 2 or greater) of the plurality of scanning signal lines, which m of the plurality of scanning signal lines are adjacent to each other,
the control signal supply means concurrently supplying, when r×m (where r is an integer of 2 or greater) of the plurality of scanning signal lines, which r×m of the plurality of scanning signal lines are adjacent to each other, are switched to the non-selection condition after the selection condition in which the r×m of the plurality of scanning signal lines receive the scanning signal supplied from the scanning signal supply means, the control signal to r×m (where r is an integer of 2 or greater and m is an integer of 2 or greater) control signal lines associated with the respective r×m of the plurality of scanning signal lines.

7. A method for driving a liquid crystal display device including a liquid crystal display device substrate,
the liquid crystal display device substrate including (i) a plurality of scanning signal lines provided on a substrate so as to be juxtaposed to each other, (ii) a plurality of data signal lines provided so as to cross the plurality of scanning signal lines with an insulating film being disposed between the plurality of scanning signal lines and the plurality of data signal lines, (iii) a plurality of storage capacitor lines provided correspondingly to the respective plurality of scanning signal lines, (iv) first transistors and second transistors, wherein each of the first transistors and each of the second transistors are electrically connected with a predetermined one of the plurality of scanning signal lines and a predetermined one of the plurality of data signal lines, (v) first pixel electrodes electrically connected with the respective first transistors, and second pixel electrodes electrically connected with the respective second transistors and electrically disconnected from the respective first pixel electrodes, and (vi) pixel regions each having a first sub pixel in which a corresponding one of the first pixel electrodes is provided and a second sub pixel in which a corresponding one of the second pixel electrodes is provided, the liquid crystal display device substrate further including (vii) a plurality of control signal lines provided additionally and correspondingly to the respective plurality of scanning signal lines, (viii) third transistors each electrically connected with a corresponding one of the second pixel electrodes, and having a gate electrode being connected with that of the plurality of control signal lines which corresponds to one of the plurality of scanning signal lines which is connected with the corresponding one of the second pixel electrodes, and (ix) buffer capacitor sections each including a first buffer capacitor electrode electrically connected with a corresponding one of the third transistors and a second buffer capacitor electrode electrically connected with a corresponding one of the plurality of storage capacitor lines, the first and second buffer capacitor electrodes facing each other via an insulating film,
the method comprising the steps of;
concurrently supplying a scanning signal for turning on the first and the second transistors, to every group of m (where m is an integer of 2 or greater) of the plurality of scanning signal lines, which m of the plurality of scanning signal lines are adjacent to each other; and
concurrently supplying, when r×m (where r is an integer of 1 or greater and m is an integer of 2 or greater) of the plurality of scanning signal lines, which r×m of the plurality of scanning signal lines are adjacent to each other, are switched to a non-selection condition after a selection condition in which the r×m of the plurality of scanning signal lines receive the scanning signal, a control signal for turning on the third transistors to r×m control signal lines associated with the respective r×m of the plurality of scanning signal lines.
